(19) United States
(12) Patent Application Publication
(10) Pub. No.: US 2025/0054675 A1
(43) Pub. Date: Feb. 13, 2025

(54) HELICOIDAL GUIDE FOR THE COOLING OF A MEDIUM-FREQUENCY TRANSFORMER

(71) Applicants: ABB Schweiz AG, Baden (CH); ABB E-mobility B.V., Delft (NL)

(72) Inventors: Uwe Drofenik, Zurich (CH); Filip Grecki, Rutihof, Aargau (CH)

(21) Appl. No.: 18/566,355

(22) PCT Filed: Jun. 1, 2022
(86) PCT No.: PCT/EP2022/064956

§ 371 Date: Dec. 1, 2023

(30) Foreign Application Priority Data
Jun. 2, 2021 (EP) EP21177404.7

(51) Int. Cl. H01F 27/08; H01F 27/02; H01F 27/12

(52) U.S. Cl. CPC H01F 27/085; H01F 27/025; H01F 27/12

(57) ABSTRACT

A helicoidal guide is provided. The helicoidal guide is configured and shaped for cooling an inductor and/or a transformer with a core and a first coil having a spatial gap between the core and the first coil, the helicoidal guide being placeable within the spatial gap and configured to guide a flow of coolant through the spatial gap, wherein the coolant is in direct contact with the core and/or the first coil.

### CROSS REFERENCE TO RELATED APPLICATIONS

This patent application is a National Stage Entry of PCT/EP2022/064956 filed on Jun. 1, 2022, which claims the benefit and priority of European Patent Application No. 21177404.7 filed on Jun. 2, 2021, the disclosures of which are incorporated by reference herein in their entirety as part of the present application.

### BACKGROUND

The present disclosure relates to a guide configured and shaped for cooling an inductor and/or a transformer, and to an inductor and a transformer including said guide configured to guide a coolant and to a method for cooling a transformer or an inductor.

Medium frequency transformers (MFT) have reduced weight and cost when compared to traditional 50 Hz or 60 Hz transformer of comparable ratings.

In a MFT, the low voltage (LV) coil is typically at a low potential with respect to the core of the MFT, for example a terminal of the LV coil may be grounded together with the core of the MFT.

The high voltage (HV) coil of the MFT is on medium voltage.

In typical MFT designs, the LV coil is designed as inner winding close to the core, while the HV coil is designed as outer winding.

It is more difficult to efficiently cool an MFT when compared to a 50 Hz or 60 Hz transformer due to the reduced size of the MFT.

Therefore, it is desirable to improve a cooling of a medium frequency transformer and/or of an inductor operating at medium frequency.

### BRIEF DESCRIPTION

The disclosure is defined by the independent claims. The dependent claims define further embodiments of the disclosure.

### BRIEF DESCRIPTION OF THE DRAWINGS

FIG. 1 illustrates an inductor and a transformer according to embodiments of the present disclosure.

FIG. 2 illustrates details of an inductor and a transformer according to embodiments of the present disclosure.

FIG. 3 illustrates a flow of coolant according to embodiments of the present disclosure.

FIG. 4 illustrate details of a helicoidal guide according to embodiments of the present disclosure.

FIG. 5 illustrates details of a helicoidal guide according to embodiments of the present disclosure.

### DETAILED DESCRIPTION

A transformer receives an input AC current at an input voltage and produces an output AC current at an output voltage, transferring the input power applied to the transformer to an output power. A transformer includes a first coil and a second coil and a transformer core that may be formed for example by laminated steel and/or by high permeability materials.

The transformer core provides a mutual inductance between the first coil and the second coil such that a current flowing in one coil induces an electromotive force (voltage) across the other coil.

The coil receiving electric power is called the primary coil and the coil outputting electric power is called the secondary coil.

The current produces a significant amount of heat due to Joule heating and therefore it may be necessary to cool the high-voltage coil, but in particular the low-voltage coil which has less cooling surface, and/or to dissipate the generated heat to prevent an overheating of the transformer.

It may also be beneficial to cool the core.

An inductor is formed by a coil and typically includes an inductor core.

In the present disclosure, an inductor is a system including an inductor core and a first coil, that presents a self-inductance, i.e., a voltage is induced across the terminals of the first coil when a current flows in the first coil.

If a second coil is present, typically wound around the core, a mutual inductance between the first coil and the second coil arises. In the presence of mutual inductance, the system including first coil, core, and second coil becomes a transformer.

For the present disclosure, we consider an inductor as a system formed by an inductor core and a first coil. A transformer includes a core, a first coil, and a second coil. Therefore, the transformer includes a subsystem formed by a core and a first coil that can be identified with an inductor formed by said core and the first coil.

For the present disclosure therefore, we consider an inductor as being included (as subsystem) in a transformer.

In fact, a transformer can be used as inductor, in particular when leaving the terminals of the secondary coil open such that a current flowing in the secondary coil does not induce a voltage in the primary coil.

When the frequency of the input AC current is increased, a smaller core is needed to transfer the same amount of electric power in the transformer. In fact, at higher frequencies more power is transferred through the core without reaching saturation and a higher electromotive force is obtained.

The present disclosure relates in particular to medium frequency transformers, operating for example in the range from 5 kHz to 30 kHz, in particular for example at 20 KHz.

Medium frequency transformers (MFT) provide weight and cost reduction when compared to 50 Hz or 60 Hz transformers.

To minimize the size of the MFT, the core may be grounded, i.e., the core may be connected to a common ground. The secondary coil (for example the first coil of the present disclosure) is not on ground potential, but requires only low-voltage insulation to ground.

The LV coil is typically at voltages in the range from 200 V to 1 kV.

The high voltage (HV) coil of the transformer is at a medium voltage, i.e., typically at voltages in the range from 10 kV to 50 kV, for example 20 kV or for example 30 kV.

Therefore, in typical MFT designs the LV coil is designed as an inner winding being close to the core, while the HV winding is designed as outer winding.

This results in a cooling problem where an air flow at the inner side of the core leg is blocked by the yokes of the core. The consequence is a hot spot at the LV coil and at the legs of the core, which limits the total amount of power, and which can be directly translated into reduced power density [kW/dm³] and increased cost [USD/kW].

The present disclosure is directed at increasing the cooling inside a gap between the core and the inner coil of the transformer/inductor. The present disclosure provides a temperature reduction and an increased power density of a MFT, thereby reducing the relative cost of the MFT.

The inductors and/or transformers of the present disclosure operate at medium frequencies, i.e., for example at frequencies that may be in the range from 5 kHz to 30 kHz, in particular of 20 KHz. The medium frequencies may be at least one order of magnitude greater than 50 Hz.

Nevertheless, alternatively the transformers and inductors of the present disclosure may operate at any suitable frequency and/or at any suitable input and/or output voltage(s) and/or current(s).

The inductors of the present disclosure may for example operate at a voltage in the range from 200 V to 1 kV.

A low voltage across a first coil of an inductor may therefore be a low voltage in the range from 200 V to 1 kV.

The transformers of the present disclosure have a first coil and a second coil. The first coil may be placed/wound around the transformer core and the second coil may be placed/wound around the first coil and/or around the core at a greater distance than the first coil.

Medium frequency transformers according to the present disclosure may have any convenient turn ratio of the turns of the first and second coil, in particular a turn ratio of 1. The primary voltage may be greater, equal, or lower than the secondary voltage. A plurality of medium frequency transformers may be stacked to produce an overall high primary voltage. In a stacked arrangement of a plurality of medium frequency transformers, the first and/or second coils of the transformers in the plurality of medium frequency transformers may be conveniently connected in series and/or parallel to increase a primary and/or secondary voltage and/or current. A series connection of coils increases the voltage across the series while a parallel connection of coils increases the total current flowing in the coils.

The first coil may act as primary or secondary winding. The second coil may act as secondary or primary winding respectively.

The insulation requirement of the second coil of the transformer is a medium voltage, for example a medium voltage in the range from 10 kV to 30 kV, for example 20 kV. For example, in a medium frequency transformer the insulation requirement of the second coil is a medium voltage (MV), while the voltage across the second coil may be lower, for example as low as a few hundreds of V, typically in the range of some kV, for example 1 kV.

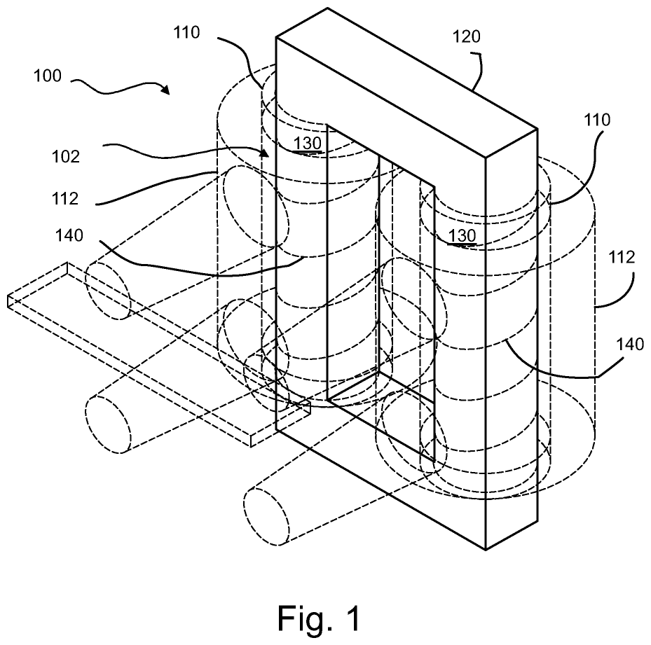

FIG. 1 illustrates an inductor and a transformer according to embodiments of the present disclosure.

FIG. 1 shows a transformer 100 with a first coil 110, a second coil 112, and a core 120. The transformer 100 is a medium frequency transformer (MFT).

The core 120 may have legs/limbs and/or core yokes, i.e., may be formed by substantially parallel segments/legs/limbs around which the first coil and/or the second coil are wound, the substantially parallel segments being coupled to each other by yokes to form a closed magnetic circuit.

The first coil 110 may be placed/wound around the core 120 and the second coil 112 may be placed/wound around the first coil 110 and/or placed/wound around the core 120 at a greater distance than the first coil 110, for example coaxially to the axis of the first coil.

The first coil is at a lower potential than the second coil.

With increasing frequency, the size of the MFT goes down. This results in volume reduction, weight reduction and, to some extent, in cost reduction of MFT as compared to 50 Hz or 60 Hz transformers.

With reduced size, the insulation distances for air insulation, which are typically several tens of centimeters in MV environments, become critical, and further size reduction is not possible. This provides a limitation of medium frequency transformer technology.

Another problem may be that, while the insulation requirements can be met by solid insulation like e.g., epoxy casting of the coils, said solid insulation prevents an efficient cooling of the coils and significantly limits the power that the MFT can handle.

To minimize the size of the transformer, the LV coil requires low voltage insulation to ground potential as well as the core.

For example, the LV coil may not be directly connected to ground but requires only low-voltage insulation to ground. The medium frequency transformers of the present disclosure may be a part of a stacked arrangement of transformers.

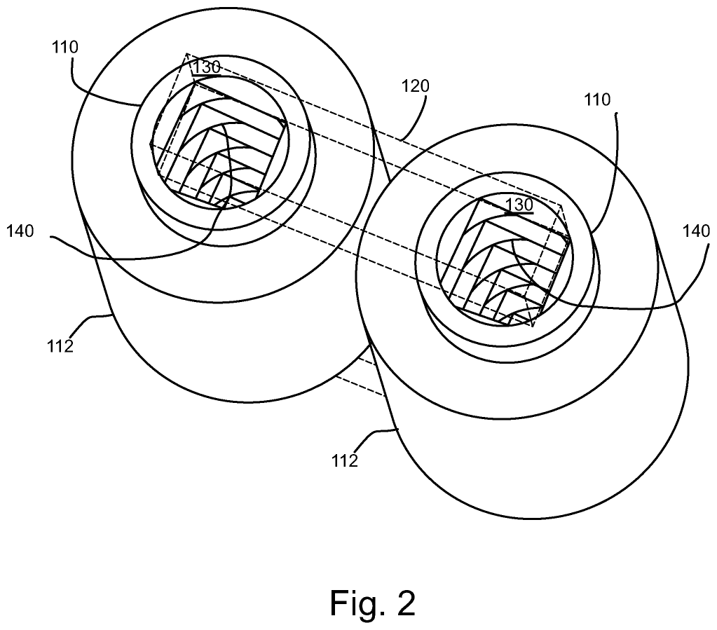

The HV-coil (i.e., the second coil 112) which is on medium voltage (typically 10 kV-30 kV) requires accordingly an insulation distance to the LV coil (i.e., to the first coil 110) and to the core. Therefore, in typical MFT designs, the LV coil (i.e., the first coil 110) is designed as inner winding being very close to the core, while the HV coil (i.e., the second coil 112) is designed as outer winding as exemplarily illustrated in FIG. 1 and FIG. 2.

This results in a cooling problem of the inner first coil 110 and the inner core 120.

A spatial gap 130 between the first coil 110 and the core 120 allow forced convection cooling. A typical problem related to said cooling is that an air flow in the spatial gap 130 is blocked/hindered by the core 120 and/or by core yokes. In fact, the core forms a closed line and thereby hinders an uniform inflow/outflow of air in and out of the spatial gap 130.

As a consequence, a temperature hot spot arises at the first coil and at the transformer core, in particular as a consequence of hindered air flow due to the core/the core yokes forming a closed loop partially obstructing/hindering the flow of air into and out from the spatial gap 130.

This hot spot limits the total amount of power of the MFT which can be directly translated into reduced power density [kW/dm³] and increased cost [USD/kW].

The present disclosure solves the problem of providing an improved flow of coolant in the spatial gap 130 between the first coil 110 and the second coil 120. The present disclosure provides increased cooling inside the spatial gap between the inner first coil surface and the core legs/limbs which results in temperature reduction and, as a consequence, in increased power density and reduced relative cost of the MFT.

When considering only the core 120 and the first coil 110, i.e., without the second coil 112 or ignoring the second coil 112, an inductor according to the present disclosure is obtained.

For the inductor the same problems are present and the same solutions are provided as for the transformer. In particular the cooling of the first coil 110 and of the core 120 of the inductor is improved.

All the disclosures of the present description that relate to a transformer, also similarly hold for an inductor obtained removing and/or ignoring the second coil and/or leaving the second coil open.

The present disclosure provides a helicoidal guide 140 configured and shaped for cooling an inductor and/or a transformer 100 with a core 120 and a first coil 110 having a spatial gap 130 between the core 120 and the first coil 110, the helicoidal guide 140 being placeable within the spatial gap 130 and configured to guide a flow of coolant through the spatial gap, wherein the coolant is in direct contact with the core and/or the first coil.

The present disclosure further provides an inductor 102 including an inductor core 120, a first coil 110 of the inductor 102 formed by an electrically insulated winding wound around the inductor core, a helicoidal guide 140, wherein a spatial gap 130 is present between the inductor core 120 and the first coil 110 of the inductor, the helicoidal guide being 140 placed in the spatial gap 130, and wherein the helicoidal guide is configured to guide a coolant in the spatial gap, the coolant being in direct contact with the inductor core 120 and/or with the first coil 110 of the inductor.

The present disclosure further provides a transformer 100 including an inductor 102 wherein the inductor core 120 forms a transformer core 120 and the first coil 110 of the inductor forms a first coil 110 of the transformer 100, a second coil 112 of the transformer formed by a winding insulated from the first coil, wherein a spatial gap 130 is present between the transformer core 120 and the first coil 110 of the transformer, the helicoidal guide 140 being placed in the spatial gap 130, and wherein the helicoidal guide 140 is configured to guide a coolant in the spatial gap 130 that cools the first coil 110 of the transformer 100 and/or the transformer core 120, the coolant being in direct contact with the transformer core 120 and/or with the first coil 110 of the transformer.

FIG. 2 illustrates details of an inductor and a transformer according to embodiments of the present disclosure.

In FIG. 1 and FIG. 2 both the first coil and the second coil are split in two parts, to better use the space around the core.

It is intended that the first coil and/or the second coil may be split into any convenient number of parts. In particular, the first coil and/or the second coil may be formed with only a single part, i.e., as a uniform single winding.

Moreover, the core may have any convenient geometry to form a closed magnetic circuit. In particular a varying number of legs/limbs may be present coupled by a varying number of yokes. In particular, for example, the transformer may be a three-phase transformer with three legs/limbs.

The present disclosure provides a helicoidal guide 140 that guides a flow of coolant, for example air, in the spatial gap 130 between the core 120 and the first coil 110.

The helicoidal guide 140 provides for example air flow guidance in the spatial gap between the surface of the inner first coil 110 of medium frequency transformer (MFT) 100 and the leg of the transformer core 120.

According to the present disclosure, a circular coolant flow in coil-axial direction around the core leg is provided for an improved cooling of both, core, and coil. The present disclosure solves the problem of coolant flow being partly blocked by the core yokes at top and bottom, and the pitch of the helicoidal guide structure can be set to optimize the speed and volume of the coolant flow, resulting in optimum utilization of a fan producing the flow of coolant. The coolant may in particular be air.

The helicoidal guide 140 is placed in the spatial gap 130 between the core 120 and the first coil 110. In particular the spatial gap 130 may surround the leg of the core 120 around which the first coil is wound in the space between the core and the inner surface of the first coil (the surface of the first coil towards the core).

If the first coil is split into a plurality of parts, for example wound around different legs, then spatial gap 130 between the first coil 110 and the core 120 may extend around said different legs. For example, in FIG. 1 and FIG. 2 each of the first coil 110 and second coil 112 has two parts placed around two legs of the core 120 respectively. The spatial gap 130 is then present around both legs (as illustrated on the left and right of FIG. 1 and FIG. 2 respectively).

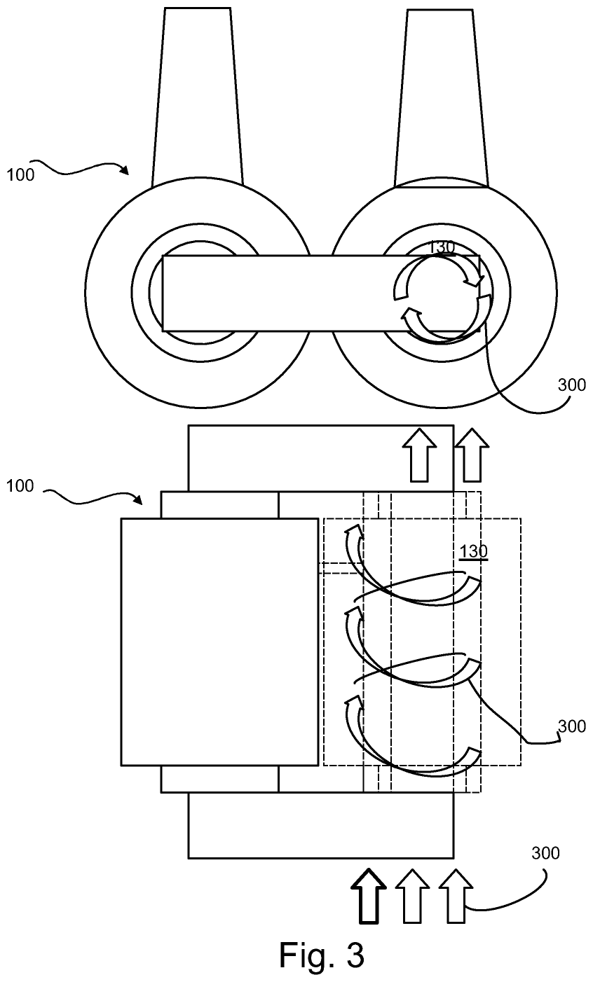

FIG. 3 illustrates a flow of coolant according to embodiments of the present disclosure.

The helicoidal guide 140 is located in the spatial gap 130 between the core and the first coil.

The helicoidal guide 140 forces a flow of coolant 300 to circulate around the core (around one or more core legs around which the first coil is wound) in coil-axial direction (or in a coil-axial direction for each part of a coil wound around a different leg of the core). The coolant is in particular air. The coolant is forced to circulate around the core leg (each core leg) in coil-axial direction (for each part of the coil wound around a different leg) resulting in improved cooling.

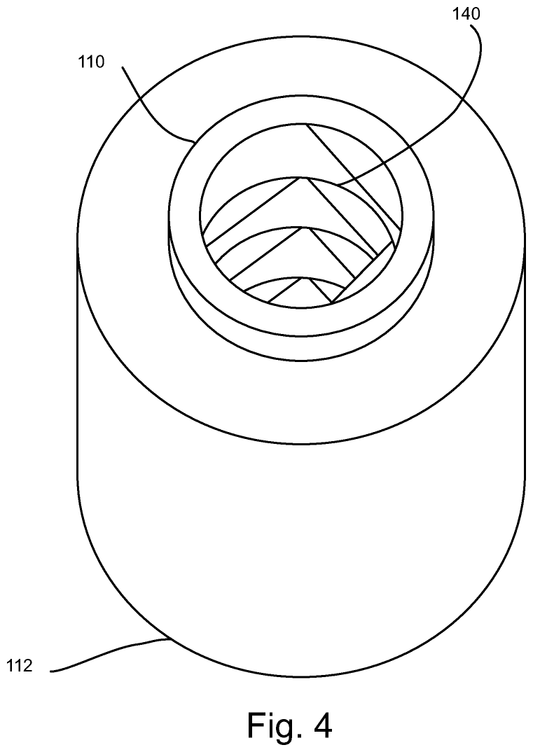

FIG. 4 illustrate details of a helicoidal guide according to embodiments of the present disclosure.

FIG. 4 illustrates in more detail how the helicoidal guide 140 penetrates into the spatial gap. The core is not shown.

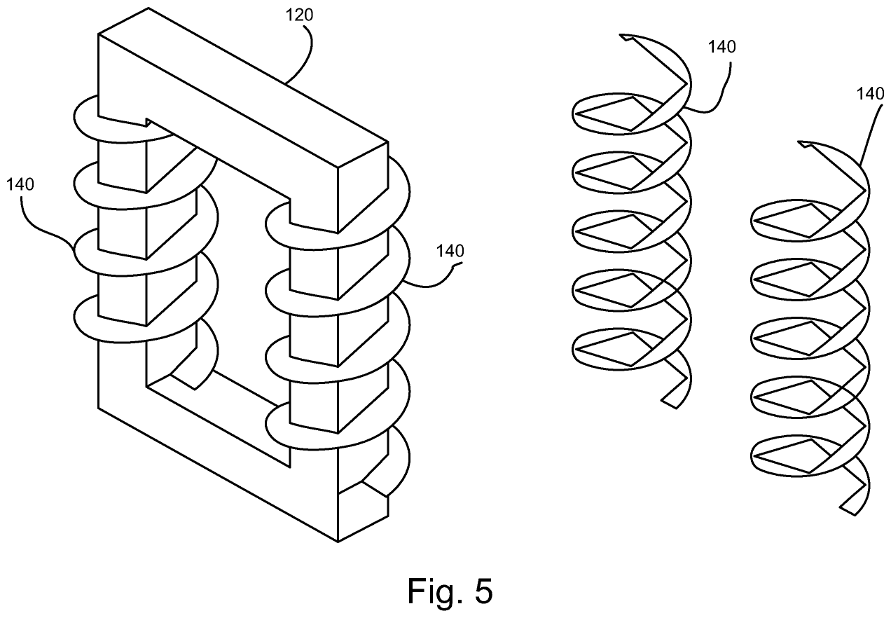

FIG. 5 illustrates details of a helicoidal guide according to embodiments of the present disclosure.

The helicoidal guide may be adapted to have an inlet configured to improve utilization of a fan.

The helicoidal guide may be engrooved inside the first coil and/or attached to the first coil.

The helicoidal guide may be part of the core (e.g., employing sintering, grooving) or attached to the core.

The helicoidal guide may be part of and/or attached to the coil (helical groove). The helicoidal guide may be part of and/or attached to the core. The helicoidal structure may be manufactured as air guidance component, to be mounted during the assembly of the MFT.

The helicoidal guide may be inserted in the spatial gap between first coil and core during the MFT assembly.

Mounting structures may be optionally attached to the first coil and/or the core to keep the helicoidal guide in place and/or in shape.

The helicoidal guide may be adapted to cores with legs with circular cross sections and/or rectangular cross sections.

The helicoidal guide nay be adapted to coils with circular shape and/or rectangular shape.

In particular, the helicoidal guides may be adapted as to allow a flow of coolant along the helicoidal shape of the guide, without coolant bypassing the turns of the helicoidal guides.

The transformers of the present disclosure may be oil transformers and/or three-phase transformers.

In particular FIG. 5 illustrates that the helical guide 140 may extend around different legs of the core 120, in particular when the coils are split into parts wound around different legs and/or in the presence of three-phase transformers.

Two legs are exemplarily shown, but the number of legs and the geometry of the core may be any known geometry/arrangement for a transformer.

The helicoidal guide may for example have a pitch of at least 2 cm and/or of at most 50 cm. For each leg, the helicoidal guide may for example include two or more turns.

The pitch and/or the total length of the helicoidal guide may be adjusted to optimize a cooling performance of a fan. For example, the pitch of the helicoidal guide may be adjusted in function of a pressure difference of the coolant flowing along the helicoidal guide and/or to increase a flow rate of the coolant flowing along the helicoidal guide and/or to maximize the heat transfer from the first coil and/or from the core to the coolant (for example air) and/or to maximize said heat transfer divided by a power consumption of the fan. The shape of the helicoidal guide may therefore result from a nonlinear optimization problem taking into account the cooling performance of the coolant and the required power for the fan, to obtain a maximum of cooling with or without constraints on the power consumption of the fan. The optimization problem may further take into account a noise level produced by the fan, for example as a constraint to keep the noise produced by the fan below a threshold.

The helicoidal guide may be made of epoxy and/or metal and be designed as to avoid or minimize Eddy currents in the guide.

The present disclosure provides several advantages:

The cooling of the medium frequency transformer is improved and a more homogeneous temperature distribution of the core and the first coil is obtained.

The power density [kW/dm³] of the MFT is increased.

The relative cost of the MFT [USD/kW] is reduced.

The pitch of the helicoidal guide can be adjusted such that the speed and volume of the coolant (e.g., air) is optimized, resulting in an optimized utilization of a fan that produces the coolant flow, for example providing a maximum of heat transfer to the coolant with a minimum of power needed for the fan.

The helicoidal guide is a simple and reliable structure providing a low-cost solution to improve the cooling.

The helicoidal guide can be applied to more general transformers and inductors.

The helicoidal guide can be employed also for oil-type MFTs. The transformers of the present disclosure therefore are not only air-cooled MFT, but may also be oil-type MFTs and/or transformers operated at any frequency for which a forced cooling is beneficial.

The present disclosure provides a helicoidal guide configured and shaped for cooling an inductor and/or a transformer with a core and a first coil having a spatial gap between the core and the first coil, the helicoidal guide being placeable within the spatial gap and configured to guide a flow of coolant through the spatial gap, wherein the coolant is in direct contact with the core and/or the first coil.

The transformer may be a medium frequency transformer, in particular a medium frequency transformer part of one or more stacked arrangements of a plurality of medium frequency transformers, for example in particular part of a solid state transformer.

In some embodiments, the helicoidal guide has at least two turns, and/or has a pitch of at least 2 cm and/or a pitch of at most 50 cm.

The present disclosure further provides an inductor including an inductor core, a first coil of the inductor formed by an electrically insulated winding wound around the inductor core, a helicoidal guide according to embodiments of the present disclosure, wherein a spatial gap is present between the inductor core and the first coil of the inductor, the helicoidal guide being placed in the spatial gap, and wherein the helicoidal guide is configured to guide a coolant in the spatial gap, the coolant being in direct contact with the inductor core and/or with the first coil of the inductor.

In some embodiments, the inductor further includes a fan to produce a flow of a coolant guided by the helicoidal guide in the spatial gap.

In some embodiments, the coolant is air.

In some embodiments, the helicoidal guide is attached to the inductor core and/or the helicoidal guide is attached to the first coil of the inductor.

In some embodiments, the helicoidal guide and the inductor core form a single piece.

In some embodiments, the inductor core partially obstructs the spatial gap partially hindering an inflow and/or an outflow of coolant into and/or out of the spatial gap, and the helicoidal guide is configured to produce a uniform flow of the coolant around the inductor core in the spatial gap when coolant flows in the spatial gap.

In particular said uniform flow may be obtained optimizing the form and/or geometry of the helicoidal guide, to obtain at least an improvement in the cooling by the flow of coolant.

In some embodiments, the helicoidal guide is made of insulating epoxy resin or of a conducting material being the same material of the inductor core and/or wherein the helicoidal guide is formed by electrically insulated segments and/or the helicoidal guide is engraved into the core.

In particular, the core may be a ferrite core and the helicoidal guide may be engraved in the ferrite core.

The present disclosure further provides, a transformer including an inductor according to embodiments of the present disclosure, wherein the inductor core forms a transformer core and the first coil of the inductor forms a first coil of the transformer, a second coil of the transformer formed by a winding insulated from the first coil, wherein a spatial gap is present between the transformer core and the first coil of the transformer, the helicoidal guide being placed in the spatial gap, and wherein the helicoidal guide is configured to guide a coolant in the spatial gap that cools the first coil of the transformer and/or the transformer core, the coolant being in direct contact with the transformer core and/or with the first coil of the transformer.

The transformer may be a medium frequency transformer, in particular a medium frequency transformer part of a stacked arrangement of medium frequency transformers, for example part of a solid state transformer.

The first coil may be at a low potential, although the coil does not need to be grounded. The second coil may be at a medium voltage.

First coils and/or second coils of the transformers in the stacked arrangement of medium frequency transformers including a plurality of transformers may be conveniently connected in series and/or parallel to increase an overall primary and/or secondary voltage and/or current of the stacked arrangement of medium frequency transformers.

In some embodiments, the transformer further includes electrically insulating oil to insulate the first coil from the second coil and/or the transformer is a three-phase transformer.

In some embodiments, the second coil is wound around the first coil of the transformer, in particular the second coil of the transformer forms a high voltage coil, and the first coil of the transformer forms a low voltage coil, the high voltage being greater than the low voltage.

In yet other embodiments the high voltage may be equal to the low voltage.

The second coil may for example be at high voltage and the first coil at low voltage.

The voltage across the terminals of the first coil and/or of the second coil may be any voltage, in particular a high voltage of the second coil may be a voltage that needs medium frequency insulation from the first coil and/or from the core, but still the voltage across the terminals of the second coil may have any convenient value, in particular when the transformer is a medium frequency transformer part of a stacked arrangement of medium frequency transformers. Therefore, a high voltage of the second coil is related to a medium voltage insulation of the second coil, for example an insulation insulating voltages in the range up to 50 kV, for example up to 10 kV, or up to 20 kV.

Analogously, a low voltage of the first coil is related to a low voltage insulation of the first coil. The voltage across the terminals of the first coil may be any convenient voltage.

In some embodiments, the transformer further includes a mounting structure attached to the transformer core and/or to the first coil and/or to the second coil configured to hold the helicoidal guide in place within the spatial gap.

In some embodiments, the transformer core has a circular cross section or a rectangular cross section and the first coil and second coil have a circular shape or a rectangular shape, and the helicoidal guide fits the cross section of the core and the shape of the coils.

The present disclosure further provides a method for cooling a transformer, in particular the transformers of the present disclosure, or an inductor, in particular the inductors of the present disclosure, with a core and with a first coil formed by an electrically insulated winding wound around the core, the transformer or the inductor having a spatial gap between the core and the first coil, the method including providing a helicoidal guide within the spatial gap, producing a flow of a coolant into the spatial gap, wherein the helicoidal guide is configured to guide the coolant into the spatial gap and to produce a direct contact between the coolant and the core and/or between the coolant and the first coil.

In some embodiments producing a flow is obtained using a fan and the coolant is air.

1. A helicoidal guide configured and shaped for cooling an inductor or a transformer or both with a core and a first coil having a spatial gap between the core and the first coil, the helicoidal guide being placeable within the spatial gap and configured to guide a flow of coolant through the spatial gap, wherein the coolant is in direct contact with the core or the first coil or both the core and the first coil.

2. The helicoidal guide of claim 1 having at least two turns; or
having a pitch of at least 2 cm or a pitch of at most 50 cm or any combination thereof.

3. An inductor comprising:
an inductor core;
a first coil of the inductor formed by an electrically insulated winding wound around the inductor core; and
a helicoidal guide configured and shaped for cooling an inductor or a transformer or both with a core and a first coil having a spatial gap between the core and the first coil, the helicoidal guide being placeable within the spatial gap and configured to guide a flow of coolant through the spatial gap, wherein the coolant is in direct contact with the core or the first coil or with both the core and the first coil;
wherein a spatial gap is present between the inductor core and the first coil of the inductor, the helicoidal guide being placed in the spatial gap; and
wherein the helicoidal guide is configured to guide a coolant in the spatial gap, the coolant being in direct contact with the inductor core or with the first coil of the inductor or both with the inductor core and the first coil of the inductor.

4. The inductor of claim 3 further comprising a fan to produce a flow of a coolant guided by the helicoidal guide in the spatial gap.

5. The inductor of claim 3, wherein the coolant is air.

6. The inductor of claim 3, wherein the helicoidal guide is attached to the inductor core or wherein the helicoidal guide is attached to the first coil of the inductor or wherein the helicoidal guide is attached to the inductor core and the first coil of the inductor.

7. The inductor of claim 3, wherein the helicoidal guide and the inductor core form a single piece.

8. The inductor of claim 3, wherein the inductor core partially obstructs the spatial gap and partially hinder an inflow or an outflow or both the inflow and the outflow of coolant into or out or in and out of the spatial gap, and wherein the helicoidal guide is configured to produce a uniform flow of the coolant around the inductor core in the spatial gap when coolant flows in the spatial gap.

9. The inductor of claim 3, wherein the helicoidal guide is made of insulating epoxy resin or of a conducting material being the same material as the inductor core or wherein the helicoidal guide is formed by electrically insulated segments or the helicoidal guide is engraved into the core or any combination thereof.

10. A transformer comprising:
an inductor comprising an inductor core, a first coil of the inductor formed by an electrically insulated winding wound around the inductor core, a helicoidal guide configured and shaped for cooling the inductor or the transformer or both with the inductor core and the first coil, and wherein the inductor core forms a transformer core and the first coil of the inductor forms a first coil of the transformer; and
a second coil of the transformer formed by a winding insulated from the first coil,
wherein a spatial gap is present between the transformer core and the first coil of the transformer, the helicoidal guide being placed in the spatial gap; and
wherein the helicoidal guide is configured to guide a coolant in the spatial gap that cools the first coil of the transformer or the transformer core or both, the coolant being in direct contact with the transformer core or with the first coil of the transformer or with both the transformer core and the first coil of the transformer.

11. The transformer of claim 10 further comprising electrically insulating oil to insulate the first coil from the second coil or wherein the transformer is a three-phase transformer or wherein the transformer further comprises electrically insulating oil to insulate the first coil from the second coil and the transformer is a three-phase transformer.

12. The transformer of claim 10, wherein the second coil is wound around the first coil of the transformer.

13. The transformer of claim 10, further comprising a mounting structure attached to the transformer core or to the first coil or to the second coil or to any combination thereof, and the mounting structure configured to hold the helicoidal guide in place within the spatial gap.

14. The transformer of claim 10, wherein the transformer core has a circular cross section or a rectangular cross section and the first coil and second coil have a circular shape or a rectangular shape, and wherein the helicoidal guide fits the cross section of the core and the shape of the coils.

15. A method for cooling a transformer or an inductor with a core and with a first coil formed by an electrically insulated winding wound around the core, the transformer or the inductor having a spatial gap between the core and the first coil, the method comprising:
providing a helicoidal guide within the spatial gap; and
producing a flow of a coolant into the spatial gap;
wherein the helicoidal guide is configured to guide the coolant into the spatial gap and to produce a direct contact between the coolant and the core or between the coolant and the first coil or between the coolant and the core and between the coolant and the first coil.

16. The method of claim 15, wherein producing a flow is obtained using a fan and the coolant is air.

17. The transformer of claim 12, wherein the second coil of the transformer forms a high voltage coil and the first coil of the transformer forms a low voltage coil, the high voltage being greater than the low voltage.

18. The method of claim 15, wherein the inductor includes:
an inductor core;
a first coil of the inductor formed by an electrically insulated winding wound around the inductor core; and
a helicoidal guide configured and shaped for cooling the inductor or the transformer or both;
wherein a spatial gap is present between the inductor core and the first coil of the inductor, the helicoidal guide being placed in the spatial gap; and
wherein the helicoidal guide is configured to guide a coolant in the spatial gap, the coolant being in direct contact with the inductor core or with the first coil of the inductor or with both the inductor core and the first coil of the inductor.

19. The method of claim 15, wherein the transformer includes:
an inductor including an inductor core, a first coil of the inductor formed by an electrically insulated winding wound around the inductor core, a helicoidal guide configured and shaped for cooling the inductor or the transformer or both, and wherein the inductor core forms a transformer core and the first coil of the inductor forms a first coil of the transformer; and
a second coil of the transformer formed by a winding insulated from the first coil;
wherein a spatial gap is present between the transformer core and the first coil of the transformer, the helicoidal guide being placed in the spatial gap; and
wherein the helicoidal guide is configured to guide a coolant in the spatial gap that cools the first coil of the transformer or the transformer core or both, the coolant being in direct contact with the transformer core or with the first coil of the transformer or with both the transformer core and the first coil of the transformer.
